(19) United States
(12) Patent Application Publication
(10) Pub. No.: US 2009/0252398 A1
(43) Pub. Date: Oct. 8, 2009

(54) Method and System for Creating a Three-Dimensionally-Perceived Image of a Biological Sample

(75) Inventors: Edgar A. Luther, Wilmington, MA (US); Bruce Miller, Auburndale, MA (US)

Correspondence Address: Sunstein Kann Murphy & Timbers LLP, 125 SUMMER STREET, BOSTON, MA, 02110-1618, US

(73) Assignee: COMPUCYTE CORPORATION, Cambridge, MA (US)

(21) Appl. No.: 12/098,773

(22) Filed: Apr. 7, 2008

(51) Int. Cl. G06K 9/00

(52) U.S. Cl. 382/133

(57) ABSTRACT

A method and system are provided for enhancing a two-dimensional digital image to render the image as a three-dimensionally perceived image, which is apparent with both monocular and binocular vision. The method, as applied to images of samples captured in a laser-based imaging system (such as a laser scanning cytometry system, for example), produces images with improved spatial resolution, facilitating improvements in both digital and visual analyses. The method comprises offsetting an image by either hardware or data processing techniques, along with additional data processing, including subtraction, scaling, and addition of digital representation of the two-dimensional image.

### TECHNICAL FIELD

The present invention relates to image-enhancing processing, and, more particularly, to enhancing of images of a biological sample interrogated with a laser-based source of light and creating three-dimensionally-perceived images of such sample.

### BACKGROUND ART

Various optical imaging techniques are used to measure microscopic characteristics of sample such as biological samples. Microscope-based methods of optical characterization, for example, such as laser scanning cytometry (LSC), epi-fluorescent microscopy, or confocal microscopy have gained popularity in biological sciences. LSC is a technique where one or more beams of laser light may be scanned across biological tissue or cells typically deposited on a supporting platform. Photomultiplier tubes, photodiodes, or CCD cameras are used to detect light resulting from the interaction of the tissue with the incident light and use the parameters of the detected light to characterize the tissue. The outputs of the detectors are digitized and can give rise to optical images of the areas of the tissue scanned. U.S. Pat. Nos. 5,072,382, 5,107,422, and 6002788 and US patent application 2006/0033920 each of which is incorporated herein by reference in its entirety, discuss various aspects of LSC. The optical images produced are used to automatically calculate quantitative data by the system, and can also be viewed by a user to distinguish among various features of a biological sample.

### SUMMARY OF THE INVENTION

Embodiments of the invention provide a laser scanning cytometry system for enhancing an image of a biological sample that may be possibly dyed. Embodiments of the system comprise a laser-based source of light for illuminating the biological sample, an opto-electronic sub-system for creating a digital representation of a two-dimensional image of the biological sample upon the sample's interaction with the illuminating light, and a processor, coupled to the laser-based source of light and the opto-electronic sub-system, for processing the digital representation of the two-dimensional image so as to render a three-dimensionally perceived image of the biological sample. In other embodiments, the system of the invention may additionally comprise, in conjunction with the processor, program code for transforming an image matrix of data representing the two-dimensional image to form an offset matrix associated with an offset image that may be scaled, and program code for subtracting adding and otherwise mathematically or logically manipulating a matrix derived from the offset matrix from the image matrix to create a differential matrix associated with a differential image. Transforming the image matrix may include forming the offset matrix associated with the two-dimensional image shifted according to a user-defined shift-vector. In specific embodiments, the matrix derived from the offset matrix corresponds to the scaled offset matrix scaled by a coefficient.

The embodiments of the system may further comprise, in conjunction with the processor, program code for scaling the differential matrix by a number to form a scaled differential matrix associated with the differential image with adjusted brightness and program code for adding the scaled differential matrix to the image matrix to form a processed image matrix associated with the three-dimensionally perceived image. In addition, the system may include a graphical output for displaying the three-dimensionally perceived image, which may be additionally enhanced with color, for visual analysis

In some embodiment, the system may be equipped with a user interface for providing user-defined parameters as input to the processor, wherein user-defined parameters include channel for image acquisition, spectral band for channel acquisition, and shift-vector for shifting the two-dimensional image.

Other embodiments of the invention provide for methods for creating, in a computer system, a three-dimensionally-perceived image from a single 2D-image of the biological sample that may be dyed. Such methods comprise imaging, in an optical system such as optical system of a laser scanning cytometer, the biological sample illuminated with light to create a first two-dimensional image, the first two-dimensional image acquired in a single spectral band. In addition, methods comprise spatially shifting the two-dimensional image to create an offset image represented by an offset matrix of data and subtracting a matrix of data derived from the offset matrix from image matrix of data associated with the two-dimensional image to create a differential matrix of data associated with a differential image. Spatially shifting the two-dimensional image may include shifting the two-dimensional image according to a user-specified vector. In forming the matrix of data derived from the offset matrix, the offset matrix may be scaled.

In addition or alternatively, in specific embodiments the differential matrix may be scaled to form a scaled differential matrix of data and adding the scaled differential matrix and the image matrix to form a transformed matrix associated with the three-dimensionally perceived image that may be further displayed for visual analysis. Furthermore, specific embodiments may comprise adding at least one color to at least one portion of the displayed three-dimensionally perceived image, where at least one portion being associated with at least one constituent of the biological sample empirically known to change a spectral composition of the light upon its interaction with at least one dye contained in the constituent.

Alternative embodiments provide methods for creating, in a computer system, a three-dimensionally perceived image from two 2D-images taken in different spectral bands of a sample that may be dyed. Such embodiments comprise imaging, in an optical system, the biological sample illuminated with light to create a first two-dimensional image and a second two-dimensional image, the first and the second images acquired in different spectral bands. In addition, such methods comprise spatially shifting the second image with respect to the first image to create an offset image that may be scaled, and subtracting a matrix derived from a scaled offset matrix of data associated with the offset image from a first matrix of data associated with the first image to form a differential matrix of data associated. Furthermore, the embodiments may include scaling the differential matrix to form a scaled differential matrix; and adding the scaled differential matrix and the first matrix to form a three-dimensional matrix associated with a three-dimensionally perceived image.

Finally, embodiments of the invention provide a computer program product for use on a computer system for creating, in a computer system, a three-dimensionally-perceived image of a biological sample, the computer program product comprising a computer usable medium having computer readable program code thereon, the computer readable program code including:

program code for spatially shifting a two-dimensional image, acquired in a single spectral band by imaging a biological sample illuminated with light, to create an offset image represented by an offset matrix of data that may be scaled; and

program code for subtracting a scaled derivative matrix of data from the image matrix of data associated with the two-dimensional image to create a differential matrix of data associated with a differential image, the derivative matrix being derived from the offset matrix.

In addition, a computer program product of specific embodiments may further comprise a program code for scaling the differential matrix to form a scaled differential matrix and adding the scaled differential matrix to the image matrix to create a transformed matrix of data associated with the three-dimensionally-perceived image.

### BRIEF DESCRIPTION OF THE DRAWINGS

The foregoing features of the invention will be more readily understood by reference to the following detailed description, taken with reference to the accompanying drawings, in which:

FIG. 1 shows a flow-chart of an embodiment of the invention.

FIG. 2 illustrates image offset performed according to the step of the embodiment of FIG. 1

FIG. 3 demonstrates a protocol of the embodiment employing manual inputs by the user.

FIG. 4 depicts an initial image of the biological sample and a final, three-dimensionally-perceived image transformed from the initial image according to the embodiment of FIG. 1.

FIG. 5 schematically illustrates a system of the invention processing image data according to the embodiments of FIGS. 1 and 3.

FIG. 6 demonstrates the effect of providing two images acquired in different spectral bands with the use of two spatially offset interrogating lasers to produce a three-dimensionally perceived image with increased spatial resolution according to the embodiment of the current invention.

FIG. 7 illustrates a one-dimensional model of laser scanning analysis of the sample according to the embodiment of the invention.

FIG. 8 illustrates the improvement in spatial resolution of a three-dimensionally-perceived image obtained in a computational model due to addition of a scaled differential image to the original two-dimensional image according to one embodiment of the invention.

FIG. 9 illustrates the results of improvement in spatial resolution of a scaled differential image as compared with the original two-dimensional image, obtained in a computational model according to one embodiment of the current invention.

FIG. 10 shows: (A) an original two-dimensional image, (B) a three-dimensionally perceived image formed from the original image by adding a scaled differential image to the original two-dimensional image, and (C) a three-dimensionally perceived scaled differential image. The 3D-perceived images have higher spatial resolution than the original image.

### DETAILED DESCRIPTION OF SPECIFIC EMBODIMENTS

Embodiments of the current invention describe optical imaging techniques for measuring microscopic characteristics of a sample (such as a biological sample). As a result of optical imaging according to the embodiments of the current invention, which may involve imaging with the use of a microscope, a stereographic image is created from a flat, 2D-image of a sample. The following detailed description of optical imaging methods according to the embodiments of the invention is provided with an example of laser scanning cytometry (LSC) where images of a biological sample may be produced with signal data obtained from photomultiplier tube and photodiode detectors. However, it should be appreciated that the embodiments of the invention are equally applicable to images of samples interrogated with other techniques such as, for example, epi-fluorescent microscopy or confocal microscopy, where digital images are obtained with the use of a CCD camera or some other array sensor, or other various imaging methods that may not require the use of a microscope.

Three-dimensionally-perceived images created by the embodiments of the invention from flat, two-dimensional images allow for more intuitive visual sample analysis than otherwise obtained from conventional imaging carried out in connection with cytometric or microscopic analysis of the biological tissue. To facilitate a 3D-rendering of the image, a single original two-dimensional image is spatially shifted, manually or automatically, by a specified distance in a specified direction to form an offset image with optionally varied brightness. Parameters of such initial shift or offset of the image may be provided by the user in a form of a vector. The offset image, which may also be scaled, is then subtracted from the original image to form a differential image the brightness of which may also be varied and which may be also displayed to the user. The differential image with optionally varied brightness is further added to the original image. It should be appreciated that such transformation produces the effect of visually enhancing the perception of image elements in the direction opposite to the initial offset and reduction of such perception in the direction of the offset itself. In other words, the leading edge of the resulting aggregate image in enhanced, while the trailing edge is diminished, thus producing a stereoscopic effect. Alternatively, to produce a three-dimensionally-perceived image, two images may be used that are otherwise substantially identical but obtained in different spectral bands. Such images may be produced with a monochromatic light-source on a sample containing at least one fluorescent dye. Alternatively, two images may be obtained obtained in different acquisition channels of a laser cytometer with the use of polychromatic light and/or multiple dyes.

Definitions. As used in this description and the accompanying claims, the following terms shall have the meanings indicated, unless the context otherwise requires: The terms “bright field” and “dark field” are defined as traditionally understood in optical imaging: “dark field” refers to an optical acquisition method that excludes the light not scattered by the sample from the image of that sample, while “bright field” illumination of the sample is illumination in transmitted light.

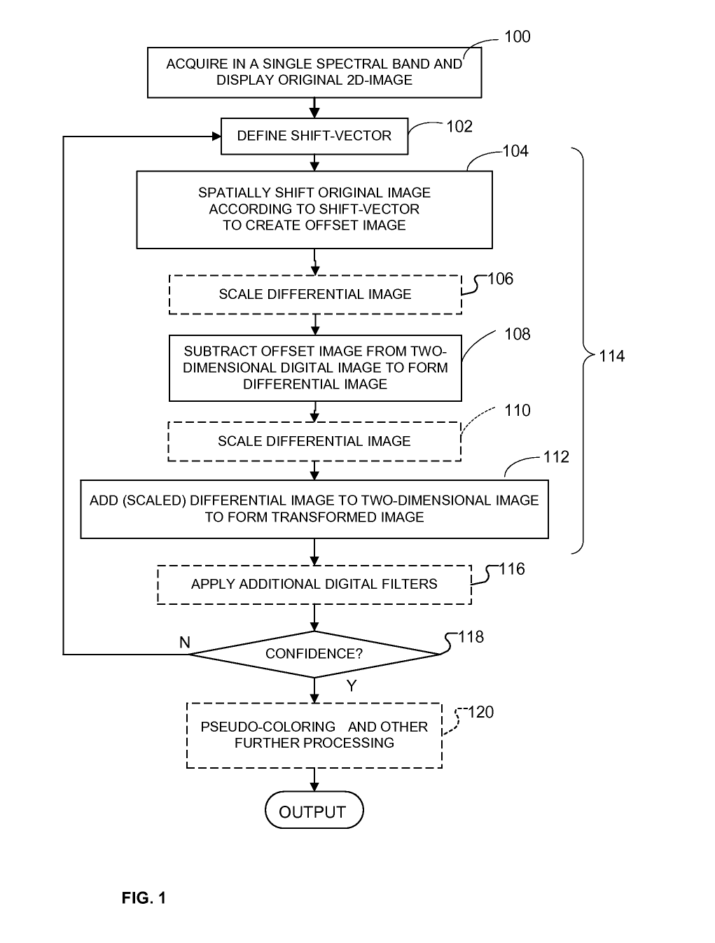

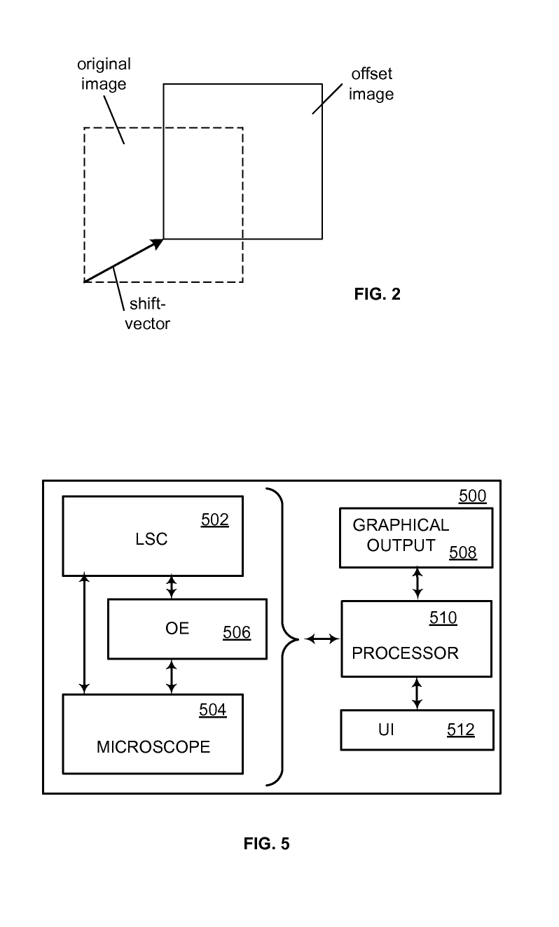

FIG. 1 provides an elementary flow-chart of an embodiment directed at creating a 3D-perceived image of a biological sample from a single 2D-dimensional original image captured in a particular spectral band. As would be readily recognized by a person skilled in the art, the original image is represented by an image matrix of data comprised of numbers associated with the irradiance of light emanating from the sample and acquired by a detector through an appropriate imaging system (such as one of the optical channels, e.g., fluorescent or absorptive, of the LSC of the invention). In one embodiment, elements of the two-dimensional image matrix correspond to pixels of a CCD-detector acquiring the original image. After the original digital image has been captured and presented to the user on a graphical display at step 100, the user has an option of digitally enhancing the original image by transforming it from being two-dimensional to being perceived as a three-dimensional image. To this end, the user may define or choose, at step 102, a shift-vector which is coplanar with the original image and characterized by direction and magnitude. Such definition or choice may be implemented through a user interface (UT) that is adequately equipped with a predetermined set of shift-vector data-processing options, containing a variety of spatial offsets and scalar factors. In the alternative embodiment, the UT may be formatted to offer the user a translation tool for custom manual definition, at the user's discretion, of a direction of the shift and a distance along the direction. The shift-vector parameters chosen by the user provide an input for a computer program product of the embodiment of the invention that spatially shifts, or offsets, at step 104, the original digital image to create an offset two-dimensional image associated with an offset matrix of data, as shown in FIG. 2. Accordingly, every data point that comprises the original image is assigned new, terminal coordinates defined as the original coordinates of that point modified by the shift-vector, according to well-known vector-algebra operations. In one embodiment, this is achieved by offsetting the data points a fixed amount in the x and the y directions.

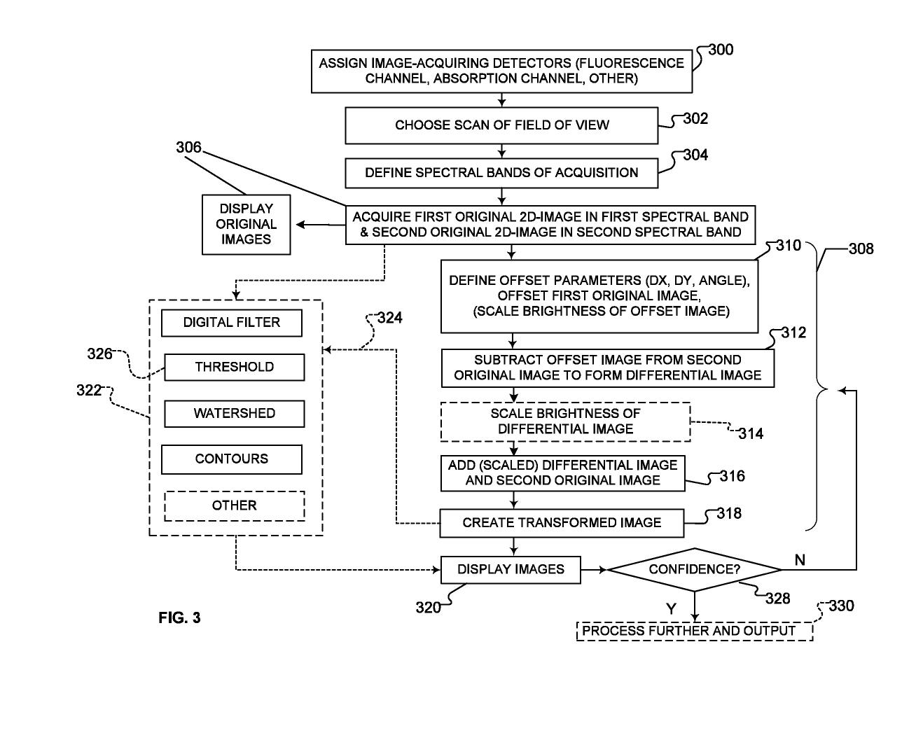

Referring again to FIG. 1, the user has an option of varying the brightness of the offset image at step 106, which is reflected in forming a derivative matrix of data by multiplying the offset matrix by a coefficient equal to a selected number. For the case where the brightness is not varied or the selected number is one, the derivative matrix equals the offset matrix. At step 108 a differential image is created by subtracting the derivative matrix from the original image matrix to form a differential matrix of data corresponding to the differential image. The operation of data subtraction produces the differential image with brightness gradients, in the direction opposite to the direction of the performed offset, being enhanced and most of other image details being at least diminished. The brightness of the differential image may also be optionally varied, at step 110, by multiplying the differential matrix by an appropriate number and thus creating a scaled differential matrix image representing a scaled differential image. It will be understood that both the differential image and the scaled differential image have the appearance of a dark-field 3D-image (and are, therefore, three-dimensionally perceived when displayed to the user and viewed with either monocular or binocular vision) and may possess information allowing for more detailed analysis of the biological sample. Brightness of images may be varied to either maintain a pre-set dynamic range of brightness in order to avoid saturation of the output image or, on the contrary, to change such a dynamic range if required. The scaling of the offset image or the differential image may be executed either automatically, with the automatic use of pre-set data-processing filters, or in response to a user input a manner similar to empirically adjusting the brightness of a computer screen. The transformed, 3D-image may be further enhanced as step 116 (as discussed in greater detail below in reference to a digital processing branch 322 of FIG. 3).

Further, at step 112, the optionally scaled differential matrix is added to the original image matrix to form a processed image matrix associated with a processed image which, when viewed by the user on a graphical display, is perceived as a three-dimensionally perceived, 3D-like image rendering the topography of the biological sample. As will be readily understood by one skilled in the art, the sequence 114 of image transformation processes discussed above and the related computer data processing, leading to the creation of a 3D-perceived image in the embodiments of the invention, can be performed using basic matrix algebra or any other known suitable method. Thus obtained transformed, 3D-image may be further enhanced as step 116 (as discussed in greater detail below in reference to a digital processing branch 322 of FIG. 3).

Referring now to FIG. 3, an alternative embodiment for generating a 3D-perceived image is described. According to this method, a 3D-like image is created from two 2D-images captured in different ways. As shown in FIG. 3, the user may input his choice 300 of detectors for image acquisition (i.e., define one or more of the available optical channels such as fluorescence or absorption channel) and specify a type of scan 302 within the field-of-view of the chosen detectors (for example, a mosaic scan or a full-field scan). In addition or alternatively, the user may define the spectral bands 304 for image acquisition (which may or may not be associated with dyes that the biological sample may contain) and request to acquire and show, 306, on the graphical display the two original images captured in the chosen spectral bands. Following the image acquisition, the protocol may offer the user to initiate and guide a sequence 308 of image-transformation choices that generally track the computerized processing sequence 114 of FIG. 1. In guiding the processing sequence 114, the user has a discretion to set-up image transformation for manually inputting various operational parameters. For example, the user may define image-offset parameters 310 subsequently used by the system of the invention to shift a first of the two images, acquired in different spectral bands, with respect to a second image to form an offset image. In addition, the user may assign optional scaling of brightness of the offset image to be subtracted, 312, from the second image, and prescribe scaling 314 of brightness of the differential image resulting from the subtraction 312, the enhanced, transformed image that is perceived to be 3D-like when displayed. Furthermore, the user may designate addition 316 of the (scaled) differential image to the second original image to form, 318, the enhanced, transformed image that is perceived to be 3D-like when displayed, 320, for further analysis. The transformed 3D-image may be presented to the user on the same graphical display with the two original images and the differential image. Alternatively, any image may be requested to be displayed independently.

The purpose of optional scaling of an image, described in reference to FIG. 1 and FIG. 3, is to optimize the perception of the final 3D-like image by maintaining the dynamic range of the resulting brightness level. In some embodiments, the operation of scaling may be implemented by multiplying a corresponding data matrix by a selected coefficient, or, alternatively, by adding the matrix to itself a specified number of times. Alternatively, scaling may be realized by repetitively adding the data matrix to itself a specified number of times or by dividing the data matrix by another selected coefficient. To this end, when both the offset and the differential images are scaled, the data associated with the offset image may be multiplied by a positive coefficient that is smaller than one prior to creation of the differential image, while the created differential image may be scaled back due to multiplication of the respective digital data by a coefficient larger than one (or division of the respective digital data by a coefficient smaller than one). Implementation of this or similar scaling sequence in a specific embodiment may allow for creation of a 3D-like final image that provides for higher spatial detail than the original two-dimensional image(s).

Referring again to FIG. 3, the created stereo-image may lend itself to deeper understanding of the constituents of the biological sample. It should be realized, therefore, that embodiments of the invention also comprise an option for additional processing of the 3D-perceived image by engaging the user with in enhanced image processing 322. The processing branch 322 may generally contain digital-processing filters used to perform various operations such as segmentation of the transformed image obtained as a result of step 318 or, for example, generation of the event data. Segmentation of the transformed image may involve a process of determining the event boundaries within a field and may be additionally calculated. In a specific embodiment, to implement such enhanced image processing operations the user may first choose to re-route, 324, the data associated with the transformed 3D-like image 318 to the enhanced processing branch 322 (e.g., as an input to the “Threshold” module 326) prior to displaying final processed image. It would be understood that a similar enhancement processing option, shown schematically at step 116 of FIG. 1, may be utilized in specific embodiments as part of the automatic image processing used for transformation of a single 2D-image acquired in a single spectral band.

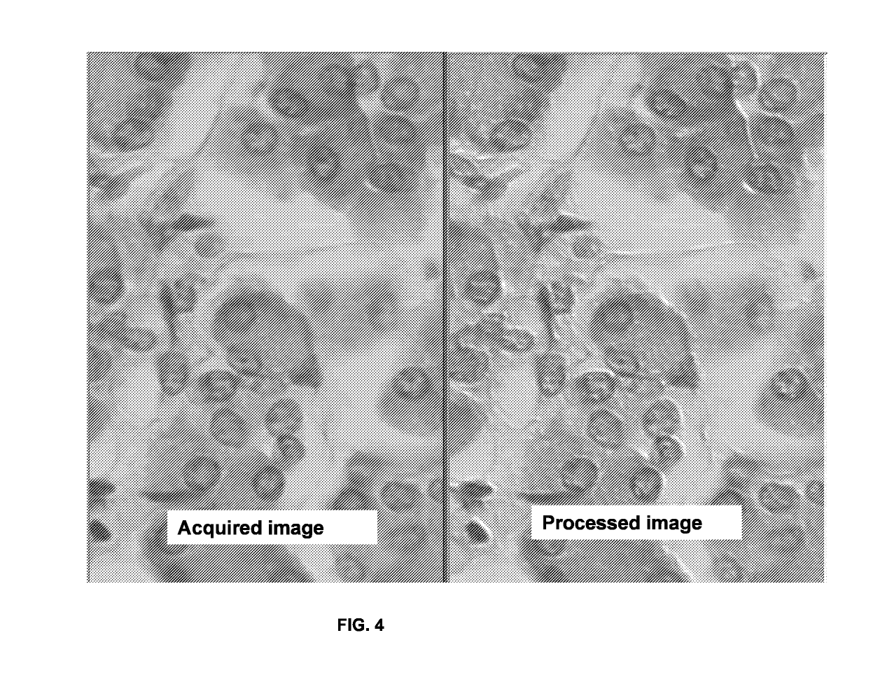

In some embodiments of the invention, the determination, of whether the resulting three-dimensionally perceived transformed image can be perceived as sufficiently three-dimensional and whether the unambiguous analysis of the image can be made, is made by the user himself. For example, as shown at step 118 of FIG. 1 or at step 328 of FIG. 3, the user may decide whether visual details of the displayed transformed 3D-image are clear and distinguished enough or further image transformation is required. In the latter case, the respective image transformation sequences 114 of FIG. 1 or 308 of FIG. 3 may be repeated with different user-input parameters. For example, the offset vector may be varied in direction or magnitude. It is recognized that the vector may be equivalently characterized in Cartesian coordinates or polar coordinates. FIG. 4 shows side-by-side two images—an original, flat monochromatic image of a biological sample and a transformed image created according to the embodiment of FIG. 1. A person skilled in the art would appreciate that the features of the transformed image appear enhanced with three-dimensionally perceived that accentuates the image constituents, thus facilitating visual analysis of the imaged biological tissue.

As is known in the biological arts, sample analysis is often performed using sections of tissues that have been stained with chromatic or fluorescent dyes. It is also known that different constituents comprising the tissue are generally characterized by different susceptibility to different dyes, and different dyes respond to, or can be “activated” by, irradiation with light in distinct spectral regions. Some of the embodiments may utilize such characteristic manner of interaction between stained biological tissue and light to create 3D-perceived images. For example, in one specific embodiment, a required 3D-like transformed image can be formed as described in reference to either FIG. 1 or FIG. 3 from corresponding original images of a dyed sample, where such original images are captured in spectral bands respectively corresponding to bands of absorption or fluorescence of dyes contained in the sample.

Two original 2D-images acquired in different spectral bands and processed according to the embodiment of FIG. 3 may be acquired substantially identically or differently in terms of systemic, optical acquisition. For example, two images of the same sample containing more than one dye and illuminated with polychromatic light may be obtained through the same fluorescent channel of the LCS-system with the same optical system at the same distance and angle and with the same magnification but in the spectral bands of fluorescence of the dyes. (As discussed in reference to FIG. 3, the choice of the channel and spectral bands of signal acquisition may be determined by user inputs.) However, it should be appreciated that in other embodiments combining images captured at slightly different angles may be also useful to render a relief-like transformed image of the sample. For example, a 2D-image obtained through fluorescence channel (i.e., in fluorescent light produced by at least one dye contained in the sample) may be appropriately paired with another 2D-image obtained under bright-field illumination conditions (i.e., in transmission through the sample) by suitable “mapping” of one of these images into the coordinate systems of the other prior to image-processing according to the embodiment of FIG. 3. Such mapping may be implemented, for example, with the use of homomorphic image processing techniques known in the art.

Furthermore, specific embodiments of the invention may allow for combining the three-dimensionally perceived image processing described in reference to FIGS. 1 and 3 with other signal enhancement techniques such as spectral deconvolution and pseudo-coloring to produce color-compensated 3D-perceived images. For example, elements of the 3D-images (produced at the output of steps 118 of FIG. 1 or 328 of FIG. 3) that correspond to different constituents of the imaged sample tissue may be enhanced by adding pseudo-colors, at respective computer process steps 120 or 330, according to color gamut associated with both dyes contained in the samples and spectral distribution of illuminating light. For example, an image portion that corresponds to a particular element of the dyed tissue known to change the spectrum of interacting illuminating light in a manner different from other elements of the tissue, may be colored in response to the user input to reflect such diverse result and to further enhance this particular portion of the image.

An embodiment of FIG. 5 illustrates a system 500 of the invention comprising a laser scanning cytometer (LSC) 502 that includes a laser-based source of light (not shown), a microscope 504, and other opto-electronic sub-systems (OE) 506 required to generate an original 2D-image of the sample (not shown) under test in the microscope upon the sample's interaction with the illuminating light. Examples of opto-electronic sub-systems 506 may include, without limitation, at least one laser-based source of light; specimen carriers and micropositioning means; photomultiplier-tube fluorescent detectors with optionally interchangeable filters, absorbance and forward scatter detectors, and CCDs, operating in different spectral bands. High-resolution imaging optics of the sub-systems 506 may including (besides detectors, relay optics, beam-splitters, and spectrally-filtering optical components such dichroic beamsplitters and diffractive optics) variable polarizers for image discrimination in polarized light, as well as optic required for bright-field and dark-field illumination of the specimen. The system 500 may be configured to repetitively scan the sample over a period of time or, alternatively, facilitate the analysis of different successive specimen and further comprise a graphical output such as a display 508 for presenting sample images to the user. Other features of the system 500 may include but not be limited to the features of LSC-systems described and claimed in patents and patent applications incorporated herein by reference.

An LSC-system processor 510, coupled to the LSC 502, the microscope 504, and the sub-systems 506 manages illumination, sample repositioning, data acquisition, processing, enhancement, and analysis of the digital images in response to user inputs defined via UT 512 of the system 500 to create a 3D-like three-dimensionally perceived image of the sample that may contain dye(s). To this end, the processor provides for computerized control of the system's hardware and for either a pre-set software analysis of the acquired image-data according to the embodiment of FIG. 1 or a use of open-architecture processing data formats according to the embodiment of FIG. 3. In alternative embodiments, processor 510 may be supplied independently from the LSC-system.

Embodiments of processor 510 may run various program codes implementing methods of the invention described above in reference to FIG. 1 and FIG. 3. For example, the processor may run the codes for transforming an image matrix of data representing a 2D-image to form an offset matrix associated with an offset image, or the program code for subtracting a matrix derived from the offset matrix from the image matrix to create a differential matrix associated with a differential image that is perceived as a 3D-image when displayed to the user. Alternatively or in addition, the processor operate program code for optionally scaling the differential matrix by a coefficient to form a scaled differential matrix associated with the differential image with adjusted brightness, or program code for adding such scaled differential matrix to the image matrix to form a processed image matrix associated with the final, processed image. As was described in detail above, both the scaled differential image and the final, processed image are perceived as three-dimensionally images when observed with either monocular or binocular vision. In addition, embodiments of the processor may execute additional enhancement of the three-dimensionally perceived image with color, and coordinate visual presentation of images, with the graphical output 508, to a user.

The embodiments of the invention described above are intended to be merely exemplary; numerous variations and modifications will be apparent to those skilled in the art. All such variations and modifications are intended to be within the scope of the present invention as defined in any appended claims. For example, the images generated according to the embodiments of the invention can be perceived as three-dimensional by both monocular and binocular vision. It would be also appreciated that original two-dimensional images can be obtained not only from a laser scanning system (such as an LSC system, used as an example herein) but any optical imaging system, which may or may not utilize a microscope, capable of producing a digital image of a sample. Implementation of the embodiments of the invention in optical imaging systems allows to increase spatial resolution of the final, transformed images as compared to the original two-dimensional images. Additionally, the offset image can be produced not only by data processing, but by other techniques such as physically offsetting (e.g., transversely) a single laser beams between consecutive exposures of the sample, or offsetting a secondary laser beam with respect to the primary laser beam (in the case of a system utilizing a plurality of lasers) from a first, or physically moving the sample between exposures. Such transverse translation may be implemented, for example, by using an appropriate translator such as a micropositioning stage.

Perception, of the image transformed according to the method of the invention, with monocular vision as a three-dimensional image is one of the advantages provided by the embodiments of the current invention. Various stereoscopic techniques require binocular vision (i.e., pairs of images) to perceive depth. The following are but a few examples of such techniques: a) stereoscopes, which require two images representing two perspectives of the same scene; b) anaglyph images, which are viewed with 2 color glasses (each lens a different color); and c) autostereograms, which are produced by horizontally repeating patterns on a background image (e.g. Magic Eye). All of these techniques require binocular vision to produce the visual perception of stereoscopic depth (stereopsis), i.e. the sensation produced in the visual cortex by the fusion of two slightly different projections of an image as received by two retinas. The methodology in the current patent produces the sensation of depth whether viewed with either both eyes or only one eye. The improvement of spatial resolution in images obtained from laser scanning systems is another very important result of use of the described embodiments. The increased spatial resolution allows for improved analysis of samples, as various subcomponents of the sample can be segmented with greater accuracy.

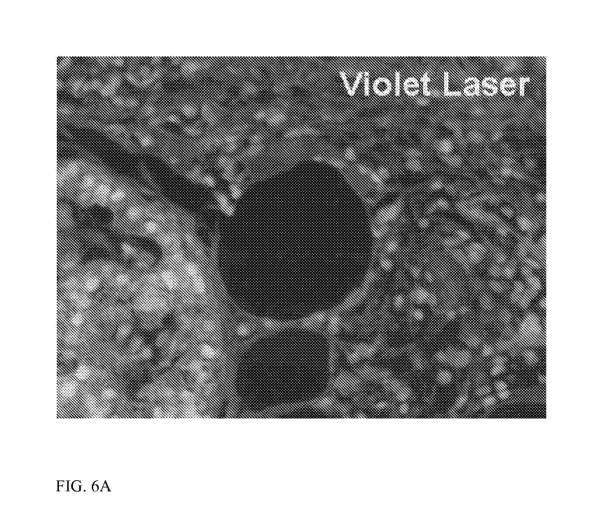

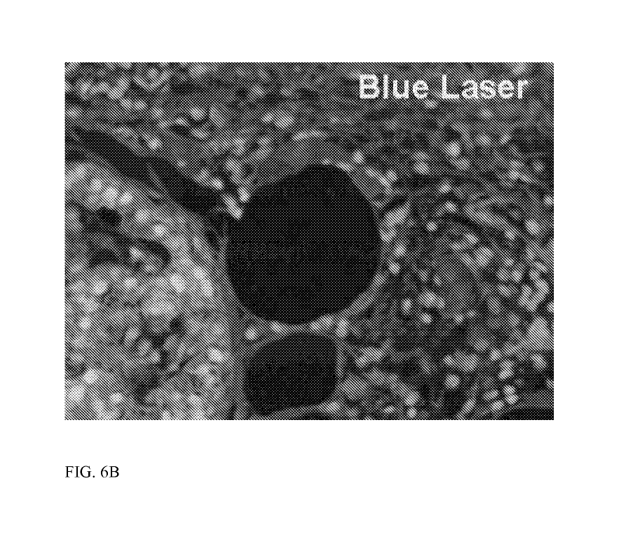

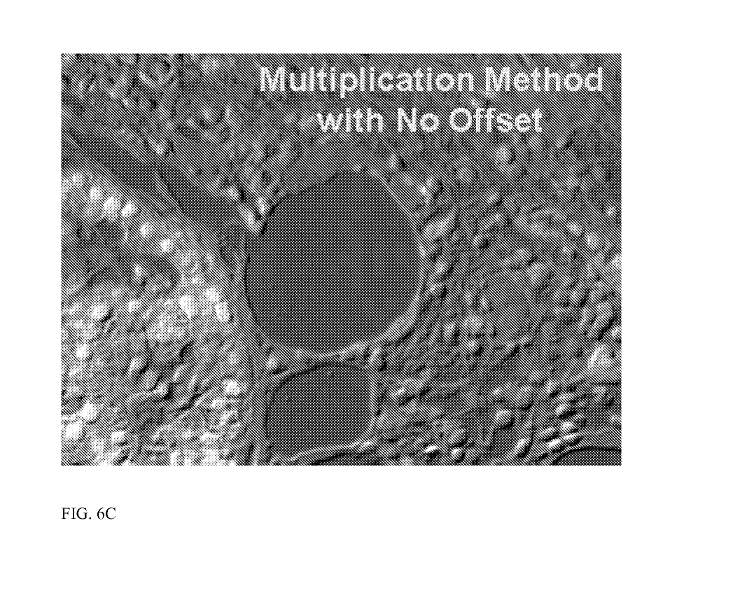

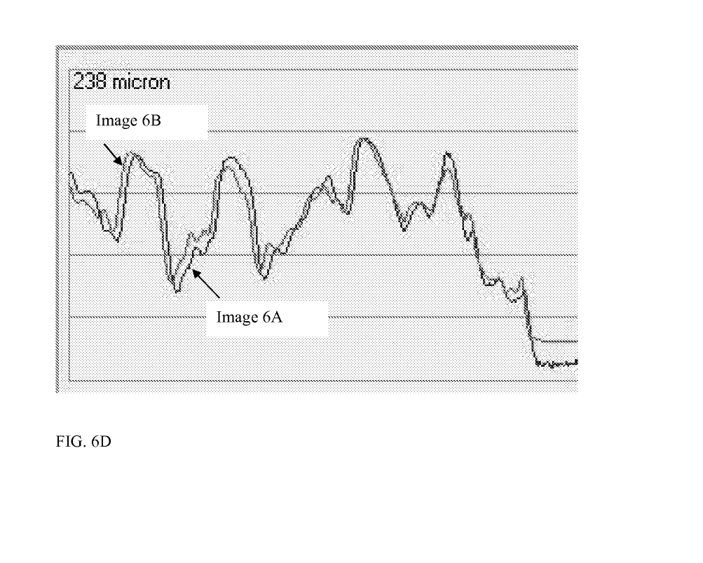

For example, in an alternative embodiment, to form a 3D-perceived image two consecutive images acquired with the same optical set-up at least a portion of which is spatially shifted between the consecutive image acquisitions. Examples of this technique include: a) in the case of a system comprising a plurality of laser sources, shifting one sample-interrogating laser transversely with respect to another laser; b) shifting a single interrogating laser transversely to the laser beam between consecutive exposures of the sample to illuminating light; c) shifting the sample itself relative to the interrogating laser between exposures; d) resizing a spot-size of an interrogating laser beam at the sample (whether independently or in comparison to the spot-size of a beam of another laser of the system) by, for example, varying parameters of the imaging system to change cross-section of the beam. An example of shifting a laser source to obtain two consecutive two-dimensional images that are later processed according to the method of the invention to form a 3D-perceived image is shown in FIG. 6. FIG. 6A illustrates an inverted light loss image of a portion of a tissue section obtained in transmission at 405 nm (“violet laser”). FIG. 6B shows an inverted light loss image of the same portion of the tissue obtained at 488 nm (“blue laser”). The results of image processing according to the embodiment of a method of FIG. 3 without taking a step 310 (i.e, without creating spatial offset between the two original images) demonstrate both the enhanced resolution and the 3D-perception effect in FIG. 6C. Panel D illustrates cross-sectional profiles for images A and B. As can be seen from Panel D, the two color images are slightly offset spatially.

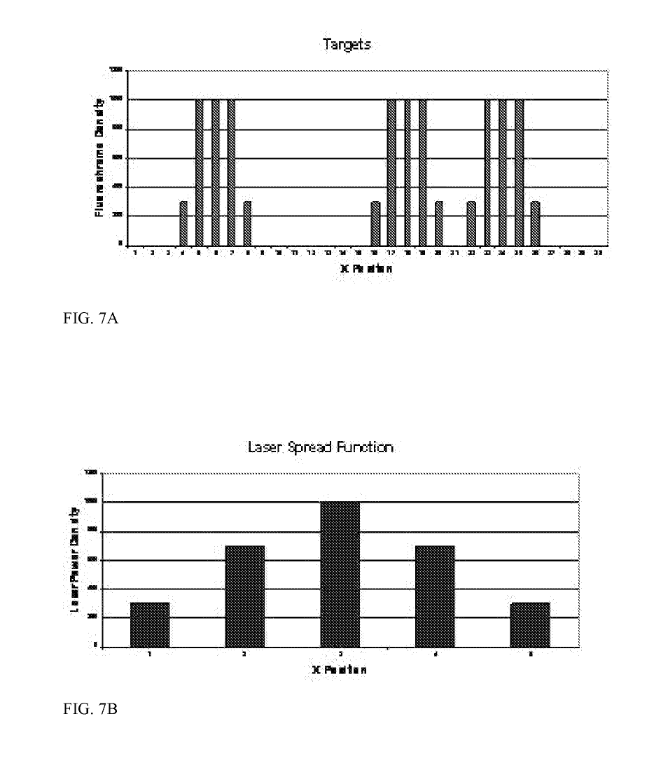

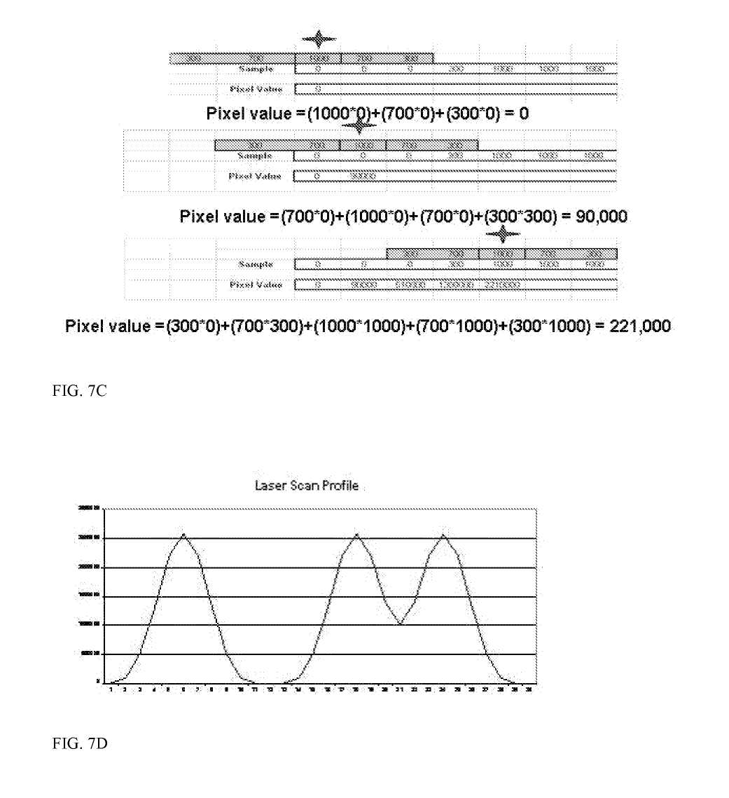

The proposed methods and systems of the invention produces additional effects of increasing the spatial resolution of the images as well as reduction in the background image noise. The cross-sectional dimensions of the scanning beam in conventional laser scanning cytometers are typically larger than dimensions of a pixel in a used imaging system, which leads to oversampling and blurring of the images. Applying the methods of this invention reduces the blurring introduced by a typical imaging system. To this end, FIGS. 7 through 9 present a heuristic model aiming to provide a one-dimensional example of a typical laser scanning analysis of the sample according to the embodiments of the invention. FIGS. 7A through 7D show a test for distribution of light upon interaction with a sample under test in an imaging system of the invention. FIG. 7A illustrates a choice of a sample target. The x-axis of the graph is divided into x increments representing the individual pixels in a laser scan. Three “objects”, each consisting of a group of 5 bars with different amounts of dye (fluorochrome) are positioned at the different locations along x-axis and separated by different distances (imitating different number of imaging pixels). This choice of the sample target emulates the fluorescence density of objects measured in laser scanning. Each of the bars in FIG. 7B illustrates the point spread function of the illuminating laser beam spread function modeled at different pixel locations. The distribution as shown 5 pixel locations, which represents 5× oversampling. Each of the sub-figures of FIG. 7C consists of 3 linear arrays. The top array contains the numerical values for the laser point spread function. The middle array contains the numerical values for the sample density function, and the third array contains the sample pixel values for the fluorescence intensity generated by the laser scanning operation. These sample pixel values are obtained by summation of the products of the laser intensity values and the sample fluorescence intensity values. The star designates the location of the active pixel. As shown n the top sub-figure (1) of FIG. 7C, the laser beam is not interacting with any portions of the sample, which results in the zero sum of the abovementioned products. This zero value is the measured fluorescence intensity for this pixel location, and is entered into the pixel value array. As shown in the middle sub-figure (2) of FIG. 7C, the active location to the right. The rightmost element of the top array (corresponding to the laser point spread function) coincides with the leftmost pixel location of the sample, so the product of the two is entered as the intensity value corresponding to the particular pixel. In the lowermost sub-figure (3) of FIG. 7C, the sampling has progressed three more pixel locations to the right. Here, several pixels on the detector register interaction of interrogating light with the sample, and the sum of the products of the laser intensity values and the sample fluorescence intensity values is appropriately entered in “pixel value” array. FIG. 7D is a plot of the laser scan profiling of the sample target of FIG. 7A (which in this model of FIG. 7 is obtained from the calculated pixel values, with the pixel locations on the x-axis and the calculated fluorescence intensity displayed on the y-axis). As expected, the laser scan profile exhibits the impact of imaging convolution: the distributions are wider than the original target values, and have a smoothed appearance. Moreover, the two closely spaced objects on the right of FIG. 7A are not completely resolvable from each other at the base (zero) line, but can be resolved at approximately 50% of the maximum intensity value.

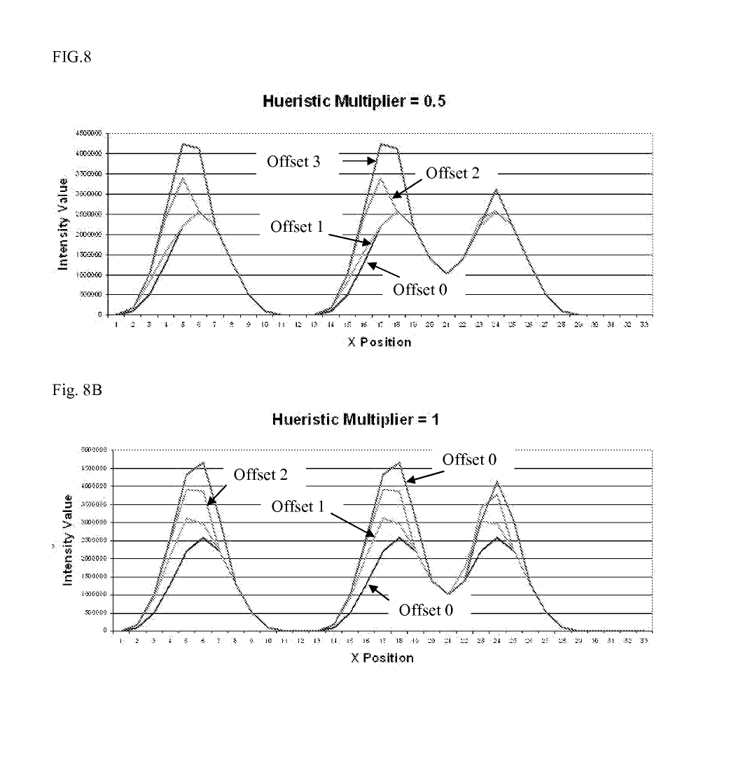

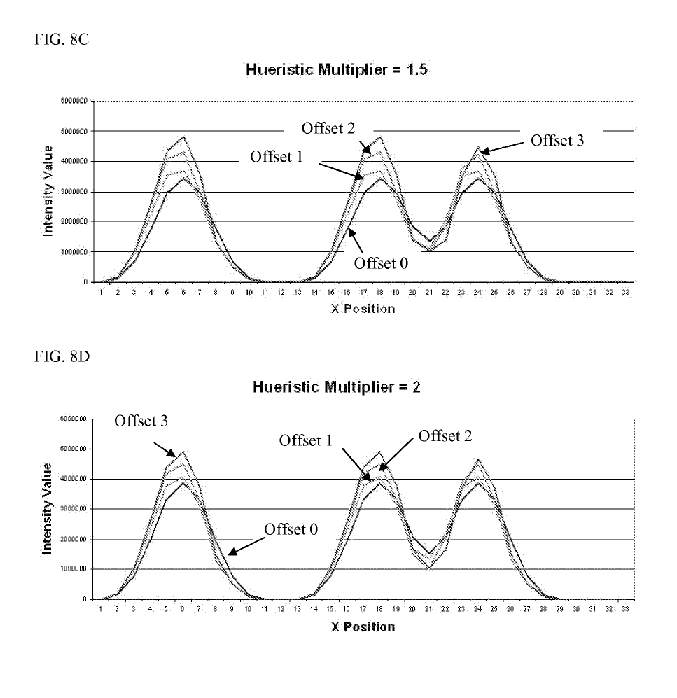

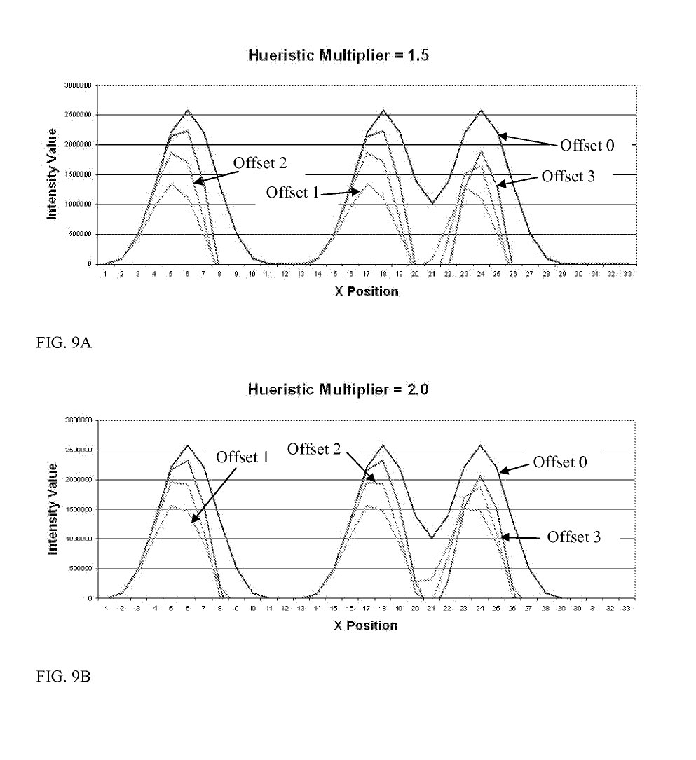

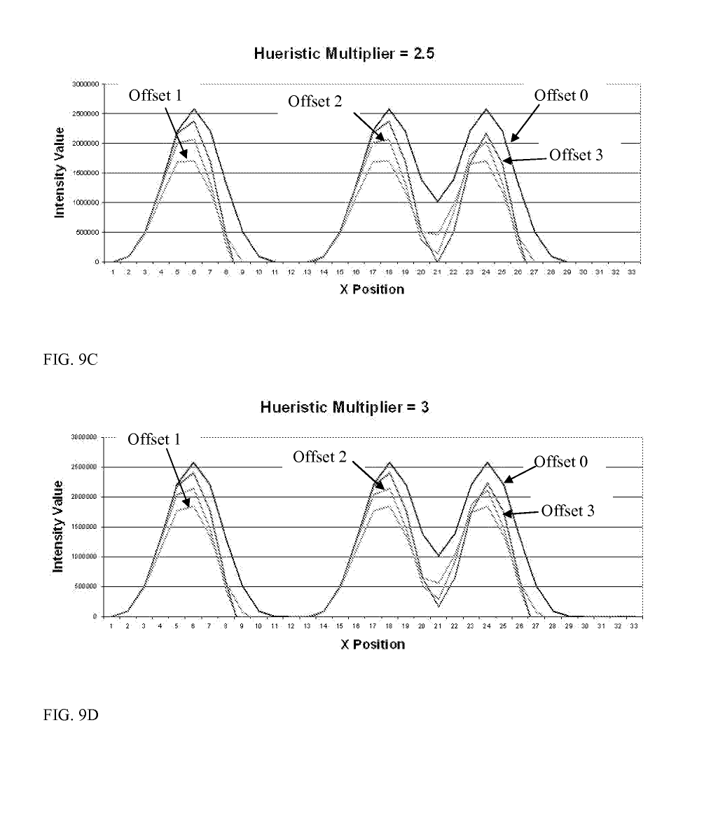

The next two figures, FIG. 8 and FIG. 9, show the results of applying the heuristic model according to the embodiments of the method of the invention to the test distribution illustrated in FIG. 7D. Two separate variables are tested. The first (“offset component” in the x-direction) represents a number of pixels by which the first image subtracted from the second original image according to step 312 of FIG. 3, for example, is offset with respect to that second original image. The results are shown for four offset values ranging from 0 to 3 pixels. The second tested variable is a number (a “scalar factor”) that is applied to the image to have it scaled according to the embodiment of the invention. FIGS. 8A through 8D show the modeled results of adding the differential matrix of data (corresponding to the differential image) to the original image as described, for example, in reference to step 316 of the embodiment of FIG. 3. Here, the values of the array to be subtracted are first scaled, and then offset by the designated amounts. Four different scaling factors are used, including 0.5, 1, 1.5 and 2. Panel B shows the results corresponding to the scaling factor (“heuristic multiplier”) of 1. The plot for the 0 offset is identical to the starting distribution. The modified profiles are increasing in intensity on the left side, inducing a non-symmetry that results in the three dimensional effect. Increasing offset amounts (FIGS. 8C and 8D) show corresponding increases in the intensity values for the resulting sample target profiles. It should be appreciated by a skilled artisan, from the increased modulation of high-to-low pixel values, that resolution of the two closely spaced objects from the right portion of FIG. 7A has improved. Increasing the multiplier value as shown FIGS. 8C and 8D decreases the difference between the subtracted and starting image.

FIGS. 9A through 9D shows the modeled results using the scaled differential matrix. Four different scaling factors are used, ranging from 1.5 to 3 in 0.5 value increments. In all of the FIG. 9, the zero offset values return the starting sample profiles. Using the non-zero offset results in decreasing the width of the target profiles, therefore effectively increasing the spatial resolution. It is worth noting that the closely spaced objects can be resolved down to base line values, which serves as another indication of increased spatial resolution.

Embodiments of the image-enhancement method, as described, increase the modulation depth of image profiles for two closely spaced objects on a darker background. The “modulation depth” figure of merit describing such two object system is defined as (M-m)/M, where M is the brightest pixel of the two objects, and m is the dimmest pixel in the region between the two objects. As can be seen in FIGS. 8 and 9, the modulation depth increases when a non-zero offset is used. Increasing the modulation depth between the two objects improves the ability of the system to separate these two objects through existing thresholding and segmentation algorithms, hence, improving the resolving capability of the system. Such improvement results in increased accuracy in segmentation of sample constituents in images obtained from biological samples.

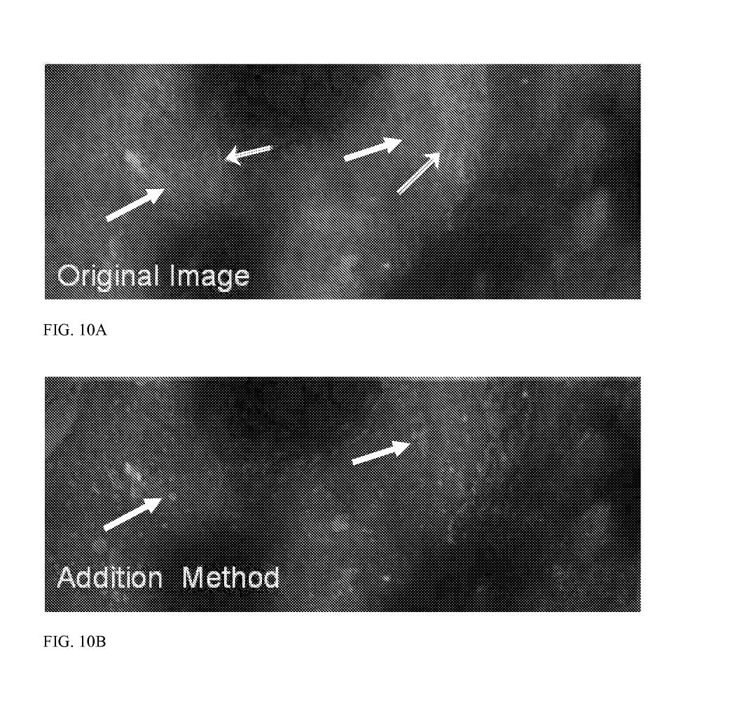

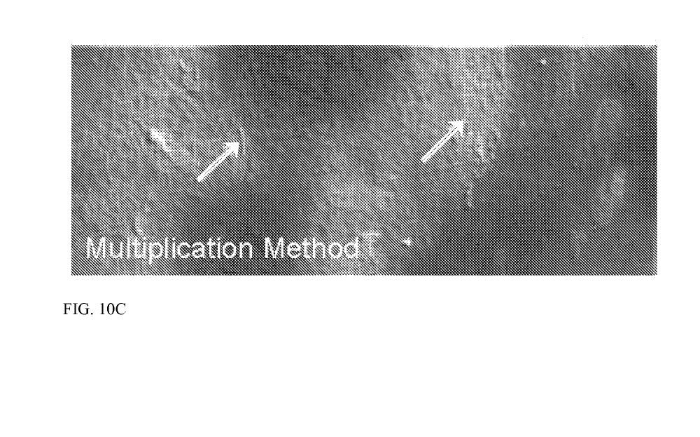

FIGS. 10A through 10C show the results of using both the scaled differential matrix and adding the original image matrix and the scaled differential matrix, as described above. In the example of FIG. 10, a standard immunhistochemistry-stained section of breast tissue was scanned with a 40× objective lens at 0.25 micron spatial resolution in the X direction. This particular section displays large amounts of green autofluorescence exhibiting considerable detail. FIG. 10A demonstrates the original uncorrected two-dimensional image. FIG. 10B shows the image obtained as a results of adding the original image and the scaled differential image. Overall, there is an enhanced three dimensional appearance to the image, and some improvement in the spatial resolution. FIG. 10 shows a scaled differential image obtained from nthe original image according to the embodiment of the invention. Arrows in FIGS. 10B and 10C through point to auto-fluorescent structures that were not visible in the original image of FIG. 10A but become apparent in the enhanced images. Overall, there is a much higher degree of three dimensionality in the image, as well as significantly improved spatial resolution. Arrows point to areas where fine structures that were detectable in the original image as low contrast entities are now much more clearly resolved from the background.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

What is claimed is:

1. A laser scanning cytometry system for enhancing an image of a sample, the system comprising:
a laser-based source of light for illuminating the sample;
an opto-electronic sub-system for creating a digital representation of a two-dimensional image of the sample upon the sample's interaction with the illuminating light; and
a processor, coupled to the laser-based source of light and the opto-electronic sub-system, for processing the digital representation of the two-dimensional image so as to render a three-dimensionally perceived image of the sample.

2. A laser scanning cytometry system according to claim 1, further comprising
a translator for repositioning the sample between subsequent exposures of the sample to the light from the laser-based source, wherein the laser-based source includes a single interrogating laser, the subsequent exposures providing the two-dimensional image and an offset image.

3. A laser scanning cytometry system according to claim 1, wherein the laser-based source includes a plurality of lasers and further comprising
a translator for repositioning the sample between an initial exposure to light from a primary laser of the plurality of lasers and a subsequent exposure to light from at least one secondary laser from the plurality of lasers, the initial and the subsequent exposures providing the two-dimensional image and the offset image.

4. A laser scanning cytometry system according to claim 2, further comprising
a translator for translating the single interrogating laser transversely to a laser beam between the subsequent exposures of the sample.

5. A laser scanning cytometry system according to claim 3, further comprising
a translator for translating the at least one secondary laser transversely to a laser beam of the primary laser.

6. A laser scanning cytometry system according to claim 1, further comprising
an imaging system for varying, between subsequent exposures of the sample to the illuminating light, cross-sectional dimensions of a beam of the illuminating light.

7. A laser scanning cytometry system according to claim 1, wherein the sample is a biological sample.

8. A laser scanning cytometry system according to claim 6, wherein varying the cross-sectional dimensions of the beam of light includes varying a spot-size of the beam of light at the sample.

9. A laser scanning cytometry system according to claim 1, further comprising in conjunction with the processor:
program code for transforming an image matrix of data representing the two-dimensional image to form an offset matrix associated with an offset image; and
program code for subtracting a matrix derived from the offset matrix from the image matrix to create a differential matrix associated with a differential image.

10. A laser scanning cytometry system according to claim 9, further comprising scaling the offset matrix by a number in forming the matrix of data derived from the offset matrix.

11. A laser scanning cytometry system according to claim 9, further comprising in conjunction with the processor:
program code for scaling the differential matrix by a number to form a scaled differential matrix associated with the scaled differential image, the scaled differential image being three-dimensionally perceived.

12. A laser scanning cytometry system according to claim 11, further comprising in conjunction with the processor:
program code for adding the scaled differential matrix to the image matrix to form a processed image matrix associated with the three-dimensionally perceived image.

13. A laser scanning cytometry system according to claim 12, further comprising a graphical output for displaying the three-dimensionally perceived image for visual analysis.

14. A laser scanning cytometry system according to claim 7, wherein the biological sample contains at least one dye.

15. A laser scanning cytometry system according to claim 11, wherein the three-dimensionally perceived image is enhanced with color.

16. A laser scanning cytometry system according to claim 9, wherein transforming the image matrix of data representing the two-dimensional image to form an offset matrix associated with an offset image includes transforming the image matrix to form the offset matrix associated with the two-dimensional image shifted according to a user-defined shift-vector.

17. A laser scanning cytometry system according to claim 9, further comprising a user interface for providing user-defined parameters as input to the processor.

18. A laser scanning cytometry system according to claim 17, wherein user-defined parameters include channel for image acquisition, spectral band for channel acquisition, and shift-vector for shifting the two-dimensional image.

19. A laser scanning cytometry system according to claim 11, wherein the differential image has improved spatial resolution as compared to the original two-dimensional image.

20. A laser scanning cytometry system according to claim 19, wherein the improved spatial resolution results in increased accuracy in segmentation of sample constituents in images of the sample.

21. A laser scanning cytometry system according to claim 12, wherein the three-dimensionally perceived image has improved spatial resolution as compared to the original two-dimensional image.

22. A laser scanning cytometry system according to claim 21, wherein the improved spatial resolution results in increased accuracy in segmentation of sample constituents in images of the sample.

23. A method for creating, in a computer system, a three-dimensionally perceived image of a sample, the method comprising:
imaging, in an optical system for measuring microscopic characteristics of the sample, the sample illuminated with light to create a first two-dimensional image in a first spectral band;
providing an offset two-dimensional image of the sample, the offset image represented by an offset matrix of data; and
subtracting a matrix derived from an offset matrix of data associated with the offset image from a first matrix of data associated with the first image to form a differential matrix of data associated with a differential image.

24. A method according to claim 23, wherein the sample is a biological sample.

25. A method according to claim 23, further comprising scaling the offset matrix in forming the matrix of data derived from the offset matrix.

26. A method according to claim 23, wherein providing the offset image includes spatially shifting the first image to form the offset image.

27. A method according to claim 23, wherein providing the offset image includes imaging, in an optical system for measuring microscopic characteristics of the sample, the sample illuminated with light to form a second two-dimensional image in a second spectral band.

28. A method according to claim 23, further comprising:
scaling the differential matrix to form a scaled differential matrix associated with a scaled differential image, the scaled differential image being three-dimensionally perceived; and
adding the scaled differential matrix and the first matrix to form a transformed matrix associated with the three-dimensionally perceived image.

29. A method according to claim 28, wherein the three-dimensionally perceived image is three-dimensionally perceived with the use of monocular vision.

30. A method according to claim 29, wherein the scaled differential image is three-dimensionally perceived with the use of monocular vision.

31. A method according to claim 28, further comprising displaying the three-dimensionally perceived image for visual analysis.

32. A method according to claim 28, further comprising displaying the scaled differential image for visual analysis.

33. A method according to claim 24, wherein the biological sample contains at least one dye.

34. A method according to claim 23, wherein the first two-dimensional image is acquired with laser scanning cytometry.

35. A method according to claim 26, wherein the spatially shifting the first image includes shifting the first image according to a user-specified vector.

36. A method according to claim 23, wherein the optical system includes a microscope.

37. A method according to claim 23, wherein the optical system is a laser scanning cytometry system

38. A computer program product for use on a computer system for creating, in a computer system, a three-dimensionally-perceived image of a biological sample, the computer program product comprising a computer usable medium having computer readable program code thereon, the computer readable program code including:
program code for spatially shifting a two-dimensional image, acquired in a single spectral band by imaging a biological sample illuminated with light, to create an offset image represented by an offset matrix of data; and
program code for subtracting a derivative matrix of data from the image matrix of data associated with the two-dimensional image to create a differential matrix of data associated with a differential image, the derivative matrix being derived from the offset matrix.

39. A computer program product according to claim 38, further comprising a program code for scaling the differential matrix by a number to form a scaled differential matrix and adding the scaled differential matrix to the image matrix to create a transformed matrix of data associated with the three-dimensionally-perceived image.
